(19) United States
(12) Patent Application Publication
(10) Pub. No.: US 2006/0047563 A1
(43) Pub. Date: Mar. 2, 2006

(54) Method for optimizing a marketing campaign

(76) Inventor: Keith Wardell, Fairfax Station, VA (US)

Correspondence Address: Brian L. Michaelis, Esq.;Brown Rudnick Berlack Israels LLP, BOX IP, One Financial Center, Boston, MA, 02111, US

(21) Appl. No.: 10/933,082

(22) Filed: Sep. 2, 2004

(51) Int. Cl. G06F 17/60

(52) U.S. Cl. 705/10

(57) ABSTRACT

A method for optimizing a marketing campaign is provided. Initially, an analysis of a client's transaction data is performed. Campaign objectives are selected based upon the findings of this analysis. Rules are selected for each campaign based upon the rules' ability to achieve the selected objectives. Based on the rules, personalized communications are delivered to achieve the client's objectives.

### TECHNICAL FIELD

The present disclosure relates generally to marketing applications, and more particularly, to optimizing marketing.

### BACKGROUND OF THE INVENTION

The Internet is making dramatic changes in the way companies market to their customers. This new channel for communicating with customers offers tremendous opportunity for companies that master its use. While every company has begun to experiment with the Internet, few have truly realized its potential. The Internet offers the potential for more meaningful and cost-effective communications with existing and potential customers. However, to truly achieve this potential, companies must change the way they view their marketing communications. To date, most companies have failed to make the changes necessary to capture the true potential of the Internet.

What is necessary to achieve the full potential of the Internet is to change the view of marketing from “company-centric” marketing to “consumer-centric” marketing. Traditionally, offline marketing channels have forced marketers to be company-centric. In these channels, the company defines the products to advertise over television, radio, print and other traditional media. The message, while tailored to the target audience, is the same for all consumers. Changes in the message may increase the appeal among one group of consumers, but often at the expense of another. Marketers spend a lot of money trying to develop the optimal message. Similarly, retailers develop one store layout designed to appeal to as many potential customers as possible. Direct mail and catalog offers are essentially the same, but only focus on those customers who fit a specific profile. In each case, the company makes the decision about the offer and delivers it to a mass audience.

The Internet offers a different approach. The online environment offers marketers the opportunity to make the transition from being company-centric to becoming consumer-centric. As a consumer-centric marketer, companies can develop offers based upon their interaction and purchasing history with each individual consumer. Done correctly, consumer-centric marketing enables the company to increase their relevance to each consumer without the potential for diluting their relevance with other consumers. For example, Internet marketers have the capability at hand to design their web sites and their email offers to appeal to each individual customer. However, to make this transition requires changing the way a company views marketing. Traditionally, companies have managed products and so ask questions like “which products are shown on TV or advertised on radio?; which products are displayed in the store or included in the catalog?; and what will be the hot new product that will appeal to the largest audience? As such, offline channels have required companies to manage products, not customers.

Despite the fact that the online channel offers the potential to move from managing products to managing customers, presently there are few, if any, effective facilities to realize such opportunities known technologies do not effectively use the transaction and browsing history of each customer to tailor the methods, timing and content of their communications with that customer.

### SUMMARY OF THE INVENTION

The present invention provides methods and apparatus for helping companies make the transition from company-centric marketing to consumer-centric marketing, and shifts the approach from managing products to managing customers. According to the present invention the problems associated with prior art marketing applications are solved by providing a multi-client, rules-based method and apparatus which uses customer transaction and clients'/subscribers' historical sales data to determine the most effective marketing offers. A brand personalization marketing model delivers campaigns using rules-based analytics on demand for clients/subscribers. The model is not limited to subscriber-specific data, but rather uses results across all participating subscribers.

The model of the present disclosures allows clients to personalize their marketing incentives and offers, by delivering certain products and/or prices to individuals most likely to purchase targeted products and services. The model analyzes transaction data and outputs findings from the analysis. Based on the findings, the model identifies marketing objectives, and determines rules most likely to accomplish these objectives. Based on these rules, the model delivers offers and incentives most likely to influence individual customer behavior.

In one particular embodiment, a method of optimizing a marketing campaign is provided, in accordance with the principles of the present disclosure. The method includes the steps of extracting a subscriber's historical transaction data from both online and offline channels; performing multiple inductive data analyses; selecting objectives for subscribers to use in website, email and wireless marketing campaigns; and delivering to each customer pre-determined offers according to rules based upon their individual transaction and click stream behavior. These rules are based upon results identified across all subscribers to identify key relationships between subscriber marketing objectives, campaign rules, and successful outcomes.

Companies who are successful at mastering these communications are able to make their communication more relevant to each individual customer without affecting their relationships with other customers. In doing this, the company becomes more relevant to more customers.

The approach described herein results in marketing campaigns that contain more relevant offers for each customer. This results in higher customer satisfaction, increased customer retention and higher sales per customer. The approach combines the science of data-driven offers with the art of judgment provided by the subscriber at each critical stage. The result is a program more likely to meet subscriber objectives and deliver meaningful communications to the subscriber's customers.

### BRIEF DESCRIPTION OF THE DRAWINGS

The foregoing features and advantages of the present invention will be understood by reference to the following description, taken in connection with the accompanying drawings, in which:

FIG. 1A is a view of the brand personalization marketing model in accordance with the principles of the present disclosure;

FIG. 1B is a view of the relationship between findings, objectives, and rules;

FIG. 2 is a view of an analysis module included in the model illustrated in FIG. 1A;

FIGS. 3A and 3B are views of value analyses performed during the analysis module;

FIGS. 4A and 4B are views of stage analyses performed during the analysis module;

FIGS. 5A and 5B are merchandising analyses performed during the analysis module;

FIGS. 6A and 6B are product affinity analyses performed during the analysis module;

FIG. 7 is a view of an objectives module included in the model illustrated in FIG. 1A

FIG. 8 is a view of a rules module included in the model illustrated in FIG. 1A;

FIG. 9 is a view of a campaign plan generated during the rules module illustrated in FIG. 8;

FIG. 10 is a view of a delivery module included in the model illustrated in FIG. 1A

FIG. 11 is a view of template development performed during the delivery module illustrated in FIG. 10; and

FIG. 12 is a view of an email matrix used in the delivery module illustrated in FIG. 10.

### DETAILED DESCRIPTION

An illustrative embodiment of the marketing optimization method and apparatus disclosed is discussed in terms of a method of optimizing an email marketing campaign. The presently disclosed method includes analyzing a client's customer transaction data, identifying marketing objectives based on the findings of the analysis, selecting marketing rules based upon the objectives, and delivering personalized emails reflective of each customer's unique purchasing behavior. However, it is contemplated that the optimization method may also be used to deliver web site, call center, or wireless campaigns.

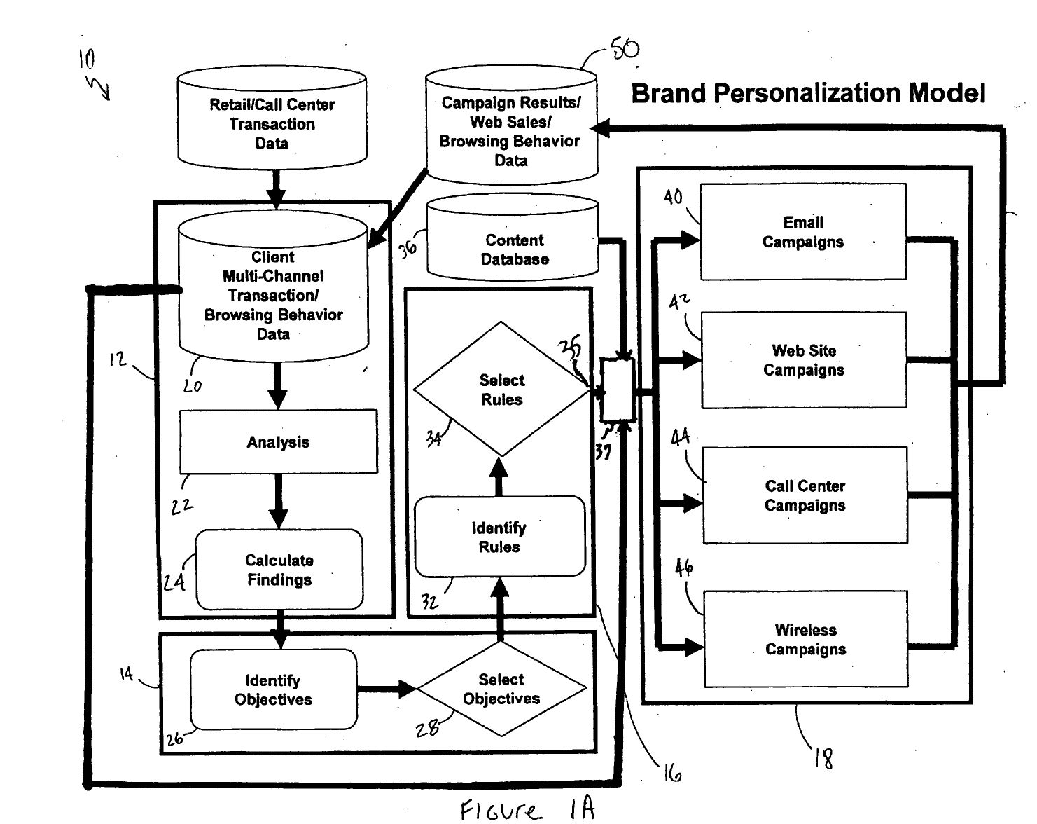

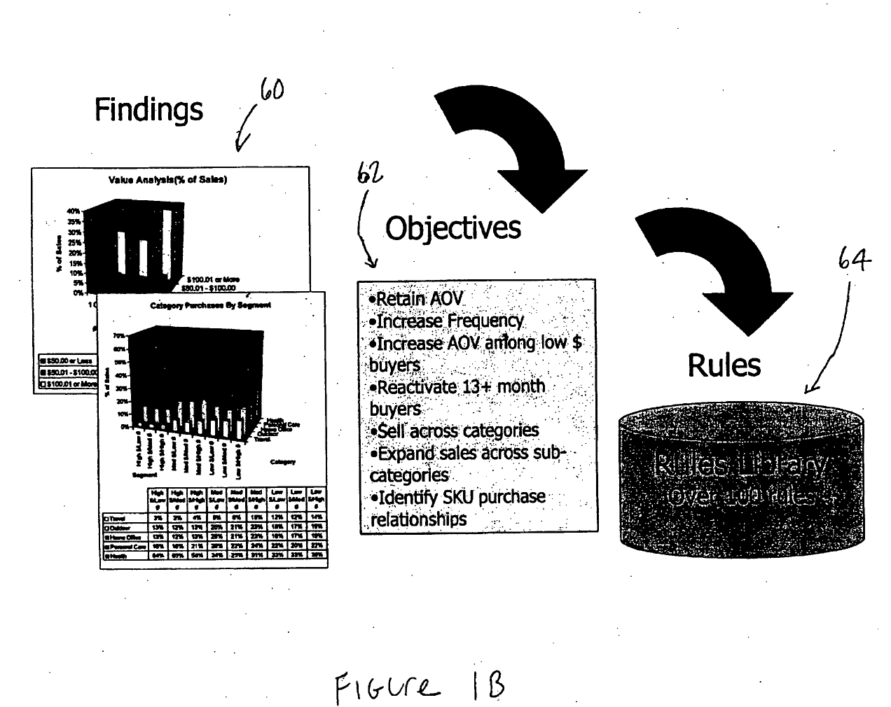

Referring now to FIG. 1A, there is illustrated an overview of a method for optimizing an email marketing campaign, constructed in accordance with the principles of the present disclosure, and referred to specifically as a “brand personalization” model 10. An analysis module 12 is used to identify strengths and weaknesses in the ways that customers interact with the client's/company's brand and offerings. In Step 20, the client provides, for example, two years of multi-channel transaction/browsing behavior data (“transaction data”). This transaction data includes data about customers from both online sales channels such as websites, and offline sales channels such as retail, call centers, and catalogs. The transaction data may include—in the case of an online channel—the clickstream information, purchase/sales data, zip codes and addresses, or other data “left behind” by customers at a client's website.

The transaction data is housed for each client and each of their individual customers in the Client Multi-Channel Transaction/Browsing Database, Step 20. This data is used in the analysis and later in determining which offer each individual customer will receive, as described in greater detail hereinafter. The data includes every transaction at the line item level (i.e. full data on each item purchased in a transaction).

In Step 22, the transaction data is analyzed to determine the unique characteristics of the client's customers. These measures include, for example, recency, order frequency, average order amount/value, value contribution, relationship stage, and product purchasing patterns at the category, sub-category and SKU level. The findings of these analyses are calculated in Step 24.

Step 26 of the objectives module 14 identifies objectives that relate to the findings from the analysis. For example, a finding of “low purchase frequency” might indicate an objective to “increase purchase frequency.” Or, a finding of “below average purchasing across categories” would lead to an objective to “increase sales across categories.” In Step 28, the client selects from the set of recommended objectives those most aligned with their online marketing goals.

Step 32 of the rules module 16 identifies potential marketing and merchandising rules, based on the selected objectives. For example, to “increase purchase frequency,” a multi-brand segmentation rule might be applied. In step 34, the client selects from the recommended set of rules a final campaign rule or rules 35 most likely to accomplish the selected objectives.

Once the final campaign rule is selected, the model returns to the Client Multi-Channel Transaction/Browsing Data, Step 20, and applies the selected rule to each individual customer of the client in question, in a rule processing step 37. For example, a rule may call for customers to receive products with a high affinity to their most recent purchase. If a client has one million customers, each of their most recent transactions is identified and the appropriate products determined for them to receive.

In any of Steps 40, 42, 44, 46 of the delivery module 18, an email, website, call center, or wireless campaign is delivered, based on the final campaign rules. In the case of an email campaign 40, personalized emails along with relevant product offers are sent to each customer. The content inserted in the emails are stored and retrieved from a content database 36.

Accordingly, in view of the above-described relationship amongst findings 60, objectives 62 and rules 64 as depicted in FIGS. 1A and 1B, the brand personalization model 10 enables delivery of products or messages to the client's customers based on, among other things, each customer's individual transaction history. More specifically, in FIG. 1B, the findings 60 are calculated based upon an analysis of the client's transaction history. From these findings 60, a set of marketing and merchandising objectives 62 are recommended and the client selects those most important to their business. Once the objectives 62 are selected, rules 64 are recommended (from a flexible and extensible library of rules) based upon their proven ability to successfully accomplish the selected objectives 62.

In Step 50, the Campaign results, web sales, and browsing behavior data are tracked and reported. For example, all click activity is tracked and retained at an individual customer level, and sales activity at the client's website is tracked for complete performance analysis. In addition, the relationships between findings, objectives and rules 60, 62, 64 are validated or revised to further improve the model 10. For example, clients can track their progress towards the selected objectives and make modifications thereto as required. In this way, the brand personalization model 10 adapts to changing relationships between findings, objectives and rules 60, 62, 64, so as to optimize delivery of campaign 40.

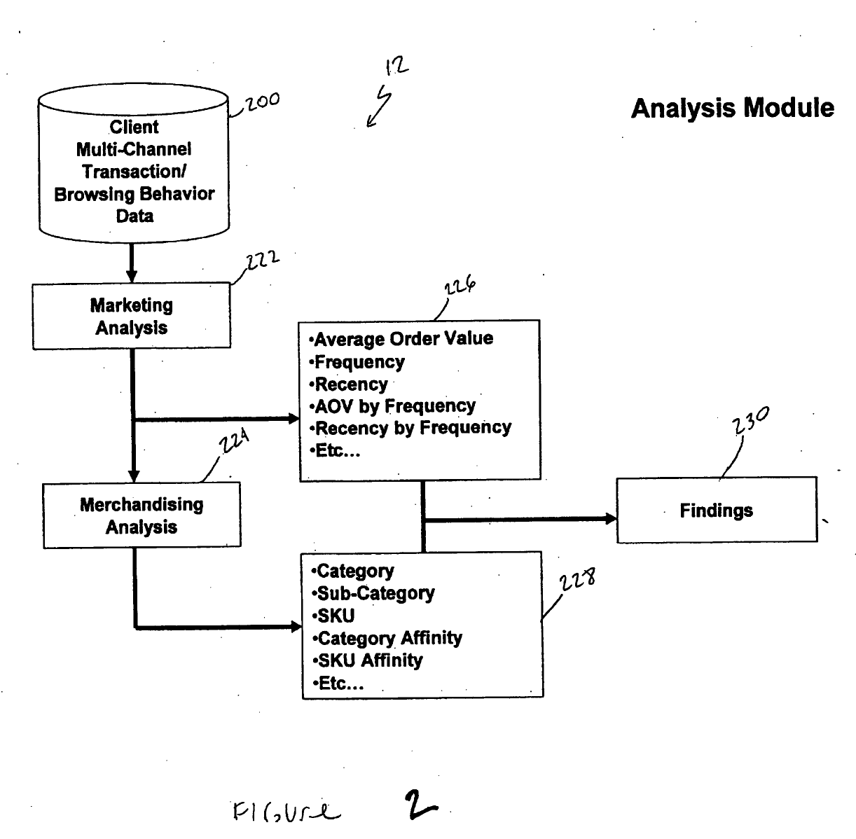

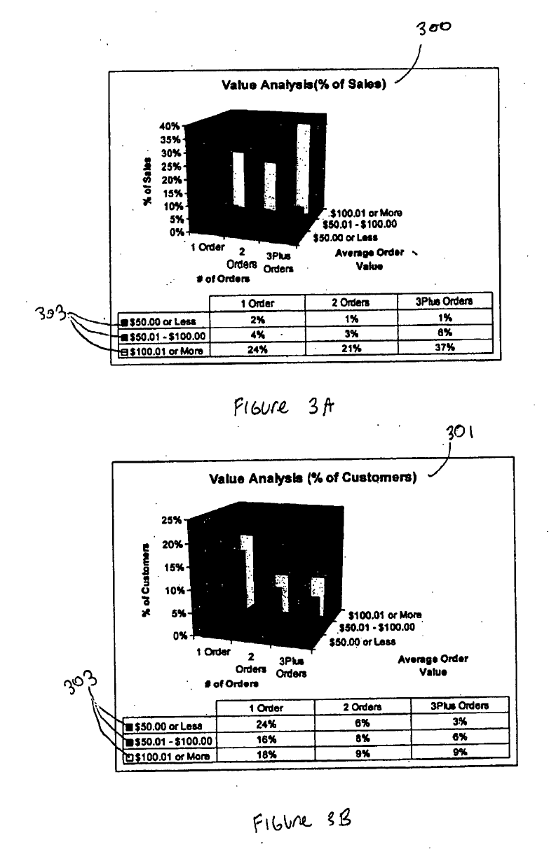

FIG. 2 illustrates the analysis module 12 in greater detail. In Step 200, the client transaction data/customer transaction file is provided. In Step 222, marketing analyses of the transaction data are conducted based upon well-known measures 226 including recency, frequency and average order value (“AOV”). For example, in FIGS. 3A and 3B, the value analyses 300, 301 look at the interaction of order frequency and average order value. These measures identify the most valuable segments of the customer base, and also those segments requiring improvement.

For example, by comparing the “percent of orders” to the “percent of sales” in FIG. 3B, each customer segment 303 can be assigned a relative value such as low, medium, or high AOV. Based on this analysis, Step 230 calculates a “Marketing Finding” that “36% of customers spend over $100 per order and account for 82% of sales.” This finding not only shows the importance of the high AOV segment, but suggests an objective of “increasing the percentage of high AOV customers.” Step 230 also calculates a finding that “33% of customers spending under $50 per order account for only 6% of sales,” which indicates an objectives of “changing pricing,” and “review new customer sources.”

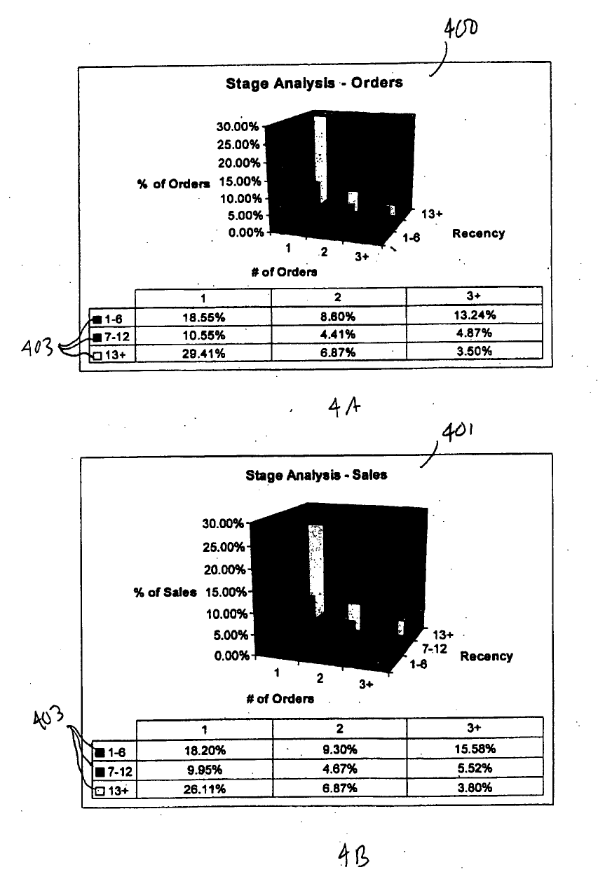

FIGS. 4A and 4B illustrate stage analyses 400, 401 that look at the relationship between recency and order frequency. These analyses identify key events/stages 403 in the customer relationship that could drive specific offers. Based on analyses 400, 401, Step 230 calculates a finding that “multi-buyers have high percentage buying in the past twelve months.” Another finding might be “37% of sales are from customers who have not purchased for over 12 months.” Thus, by analyzing buyer behavior through a life cycle of first-time buyer to multi-buyer to long-term customer, opportunities to improve customer value are identified.

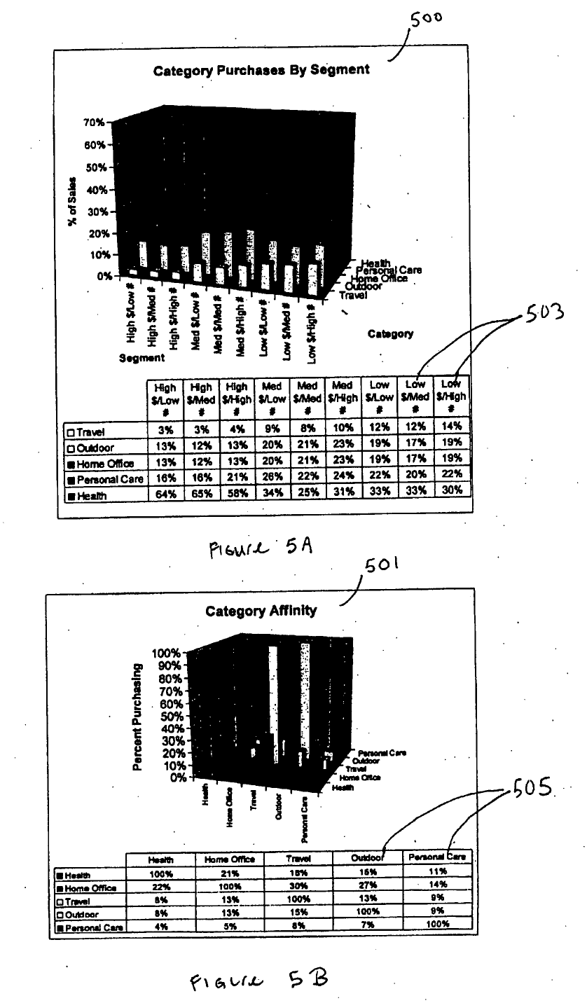

In Step 224 (FIG. 2), “merchandising analyses” of the transaction data are performed. These analyze customer segments for product purchase behavior based upon measures 228 such as product category, sub-category and SKU, or product affinity amongst category, sub-category and SKU. For example, FIG. 5A illustrates a product category analysis 500, which shows product category purchasing behavior across customer segments 503. FIG. 5B illustrates a category affinity analysis 501 used in identifying opportunities for increasing sales by selling across categories 505. Based on such analysis 501, substep 230 calculates a merchandising finding of “a low level of purchasing across categories, with the highest level being 30% between Travel and Home Office, while most categories demonstrate less than 20% of customers buying from both categories.” This finding can be used later to develop relevant merchandising objectives.

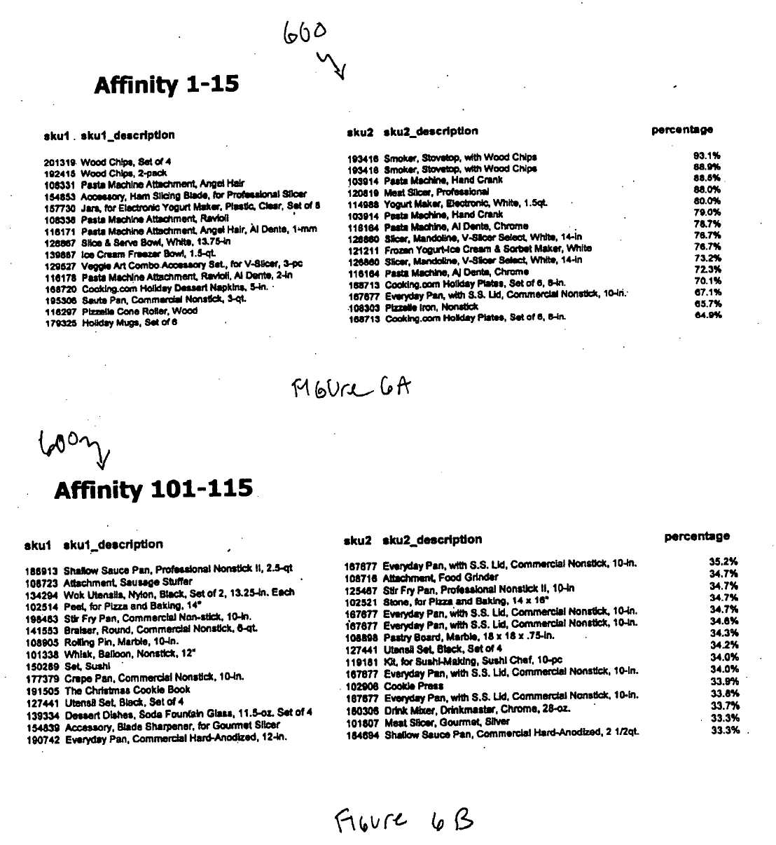

FIGS. 6A and 6B illustrate a product affinity analysis 600 that looks at pairs of products with the highest affinity, to identify specific cross-sell opportunities at the SKU level. The top 15 pairs in this example are shown in FIG. 6A, which illustrates that a high percentage of customers who purchased SKU 1 also purchased SKU 2. Looking left to right in FIG. 6A, it is evident that these products belong together and likely were purchased together. However, when looking from top to bottom of FIG. 6A, it is evident that customers purchased a wide variety of product combinations. This observation leads to calculation in Step 230 of a merchandising finding of “strong differentiation at the product level.”

When looking at the 101^{st} to 115^{th} product affinity pairs, a similar pattern is seen between SKU1 and SKU2. These products have obviously been merchandised to go together. Looking from top to bottom in the chart, the diversity of products is also evident. The difference here is that only about 35% of customers who purchased SKU1 have purchased SKU2. This demonstrates a finding of “strong potential for additional sales to purchasers of SKU1.” Other examples of marketing findings and merchandising finding are listed in TABLE 1.

TABLE 1

| Marketing Findings | Merchandising Finding |
|---|---|
| Low purchase frequency with one time | Product purchase behavior shows |
| buyers at 78%. | greater variance as the analysis |
| Since AOV varies significantly, price will | moves from category to class. |
| play an important role. | Company shows a high level of |
| 12% of customers spending $150 or more | variability across product categories |
| account for 38% of sales. | with highest variation in Health or Personal |
| 71% of orders account for 34% of sales. | Care. |
| Multi-buyers have high percentage buying | Product level affinity should |
| in the past 12 months. | demonstrate the best opportunity for |
| 37% of sales are from customers who | using merchandising to increase |
| have not purchased for over 12 months. | frequency. |
| Percent One Time Buyers | Top brands have broad appeal. |
| Percent Three or More Time Buyers | Category Sales Highest Deviation |
| AOV at 25% | Category Sales Lowest Deviation |
| AOV at 90% | Category Sales High/Low Ratio |
| AOV Ratio | Category Affinity Highest Percent |
| % of Buyers 0-6 Months | Category Affinity Lowest Percent |
| % of Buyers 13+ Months | Category Affinity Average Percent |
| Sales to Order Ratio Low Freq/Low AOV | Sub-Category Low/Low-High/ |
| Sales to Order Ratio High Freq/High | High Top 10 Overlap |
| AOV | Sub-Category Sales Ratio 1 to 20 |
| Sales to Order Ratio Low Freq/0-6 | Product Affinity Top 15 Average |
| months | Product Affinity 101-115 Average |
| Sales to Order Ratio High Freq/0-6 months | Product Affinity Ratio |
| Sales to Order Ratio Low Freq/13+ months | |
| Sales to Order Ratio High Freq/13+ months | |

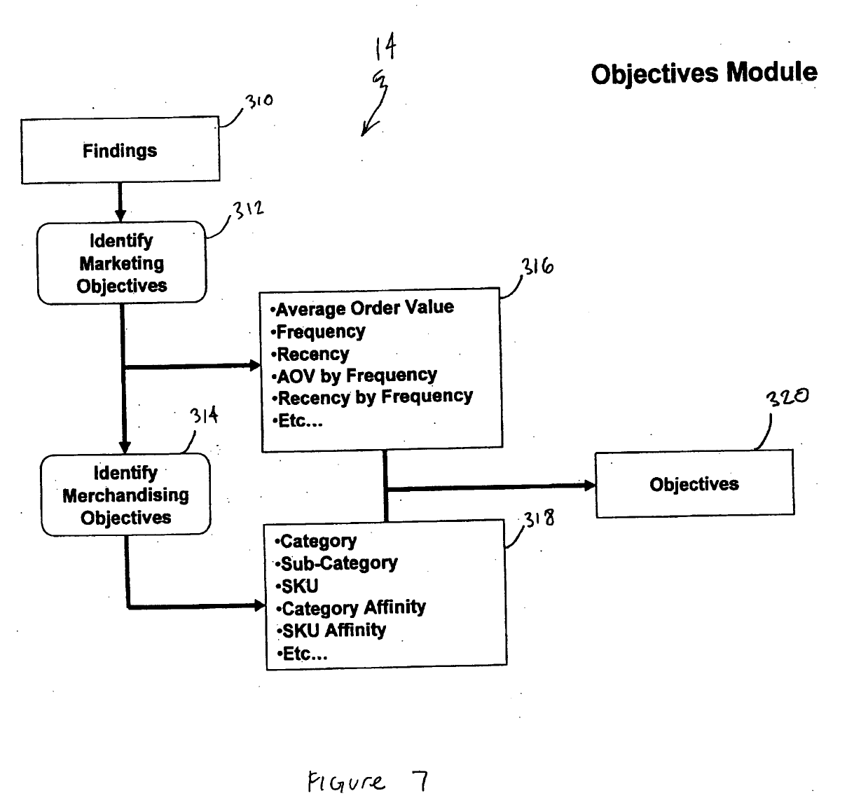

FIG. 7 illustrates the objectives module 14 in more detail. Based on marketing findings 310, corresponding marketing objectives are identified, 312. These objectives are expressed in terms of 316, for example, average order value, frequency, recency, AOV by frequency, and recency by frequency. In marketing objectives most aligned with the client's goals are selected from the set of recommended objectives, 320. The relationship between typical marketing objectives and their corresponding marketing findings is illustrated in TABLE 2.

TABLE 2

| Marketing Findings | Marketing Objectives |
|---|---|
| Low purchase frequency with one time | → Increase order frequency |
| buyers at 78%. | |
| Since AOV varies significantly, price | → Increase percentage of |
| will play an important role; | high AOV buyers |
| 12% of customers spending $150 or | |
| more account for 38% of sales; and | |
| 71% of orders account for 34% of sales. | |
| Multi-buyers have high percentage | → Reward multi-buyers |
| buying in the past 12 months | |
| About 37% of sales are from customers | → Reactivate 13+ month buyers |
| who have not purchased for over | |
| 12 months | |

Merchandising objectives in terms 318 of, for example, category, sub-category, SKU, category affinity and SKU affinity are then identified, 314. Then merchandising objectives most aligned with the client's goals are selected from the set of recommended objectives, 320. Examples of merchandising objectives as they correspond to merchandising findings 310 are summarized in TABLE 3.

TABLE 3

| Merchandising Findings | Merchandising Objectives |
|---|---|
| Product purchase behavior shows greater | → Use SKUs with high |
| variance as the analysis moves from | correlation to address one |
| category to class. | time buyers |
| Company shows a high level of variability | → Focus on selling across |
| across product categories. Highest | categories |
| variation in Health and Personal Care. | |
| Product level affinity should demonstrate | → Focus on selling within |
| the best opportunity for using merchandising | sub-categories |
| to increase frequency. | |
| Top brands have broad appeal | → Feature higher priced |
| | merchandise in email |
| | to buyers |

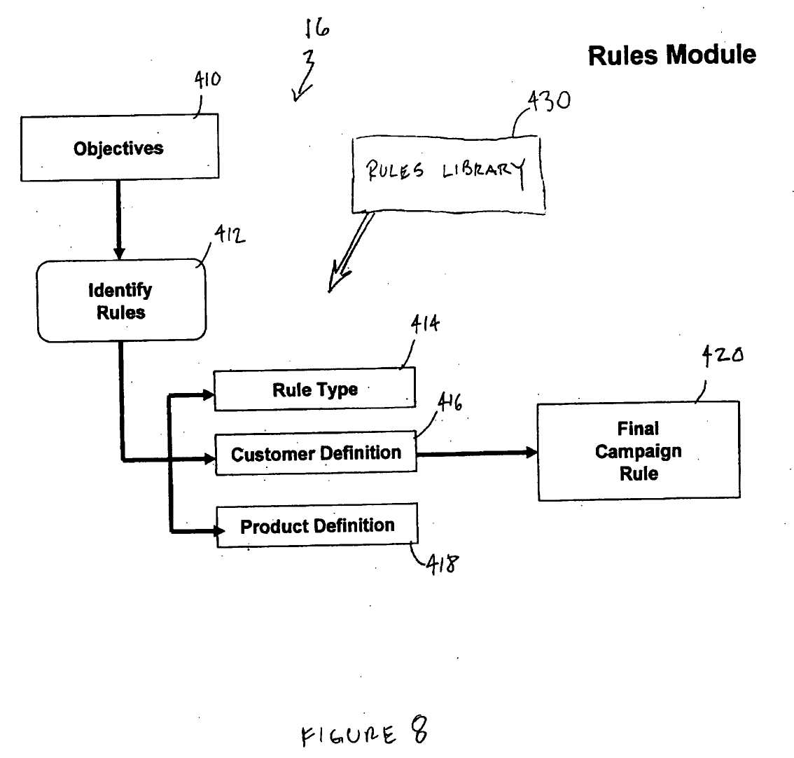

FIG. 8 illustrates the rules module 16 in more detail. In this connection, a large library 430 of marketing and merchandising rules is implemented for use in email and web site campaigns. Campaign rules are identified in Step 412 that relate to objectives 410. Each rule has a plurality of variable data elements/components. In this illustrative embodiment each rule has three variable data elements. By adjusting the components in the rules, thousands of unique rules can be generated. In this way, rules are determined 412 which are used to guide the client in accomplishing their objectives 410. That is, based on the selected list of objectives 410, the appropriate rules to be used in each campaign are determined. For example, to achieve an objective 410 of “increasing purchase frequency,” a so-called multi-brand segmentation rule might be applied. In another example, to accomplish an objective 410 of “increasing sales across categories,” a “category affinity” rule might work.

A first rule component, or rule type, is selected in Step 414. The type of rule defines the statistical treatment of the transaction data. Examples of rule types include simple segmentation, complex segmentation, product affinity, or replenishment. A second component, customer definition, is selected in Step 416. Customer definition defines the way(s) buyers are classified. Examples include SKU of most recent purchase, amount of most recent purchase, and most purchased category. A third component, product definition, is determined in step 418, and defines the method for selecting products. Examples of product definition include best sellers, new products, seasonal products, and best sellers by category. Additional examples of the three rule components appear in TABLE 4.

TABLE 4

| Rule Type | Customer Definition | Product Definition |
|---|---|---|
| Category | Most Recent Purchase | Overall Best Sellers |
| Multi-Category | Highest Total Amount | Category Best Sellers |
| Category Affinity | Highest Total Units | Seasonal Items |
| Product Affinity | Highest Price | New Products |
| Reactivation | Date of Most Recent Purchase | Price Point |
| Replenishment | Number of Purchases | Brand |
| Sales Add-On | Average Order Value | Overstocks |
| Event Driven | | High Margin |
| Educational | | |
| Liquidation | | |
| Click Stream | | |
| Multi-Channel | | |

Based on the selection of a rule type, customer definition, and product definition, a final campaign rule is determined in Step 420. For example, if the rule type, customer definition, and product definition selected are, respectively, category affinity, highest total units, and new products, then one final campaign rule might be:
“The campaign will be a category affinity based upon an analysis calculating cross category potential. The buyer's category will be selected based upon the category from which they have purchased the most units. They will receive two new products each from the category they purchased and the two highest affinity categories.”

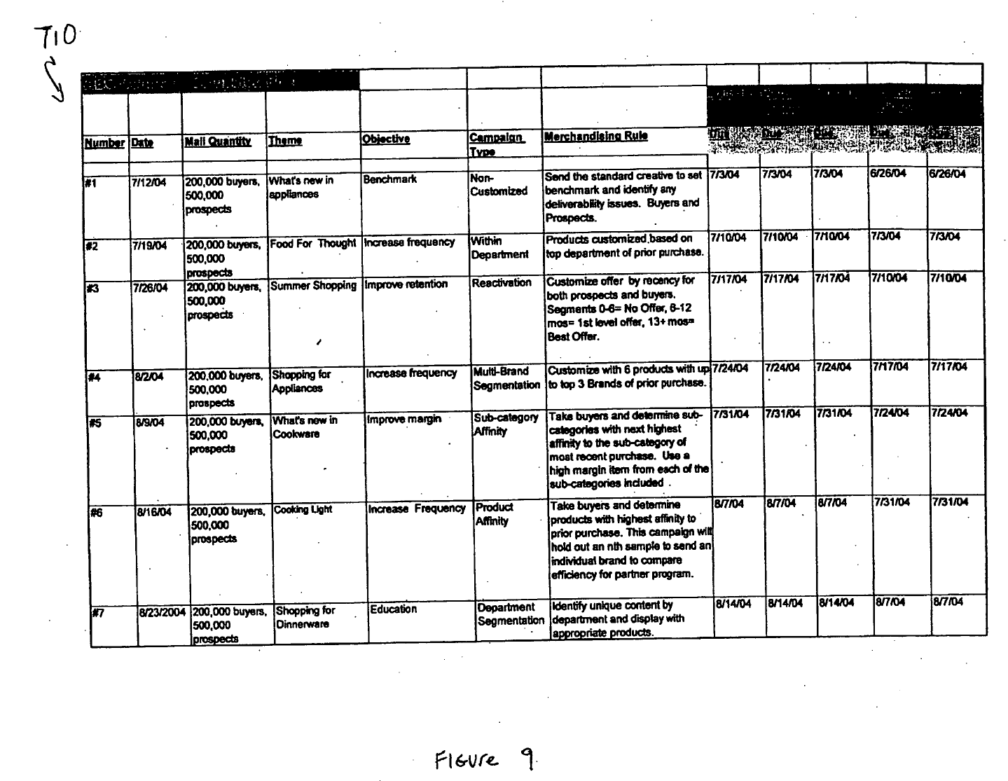

In this way, a great number of final campaign rules 420 can be developed. However, for each campaign 40, typically only one objective 410 and a corresponding rule are defined. This assures that the campaign results can be later measured against the objective 410. In this connection, FIG. 9 illustrates an example of a final campaign plan 710 also generated in Step 420. Campaign plan 710 contains the selected objectives 410 and corresponding rules, as well as information such as Campaign Theme, Mail Quantity, Template Due Date, Copy Due Date, Mail File Due Date, Category Definition Date, and Product Definition Date.

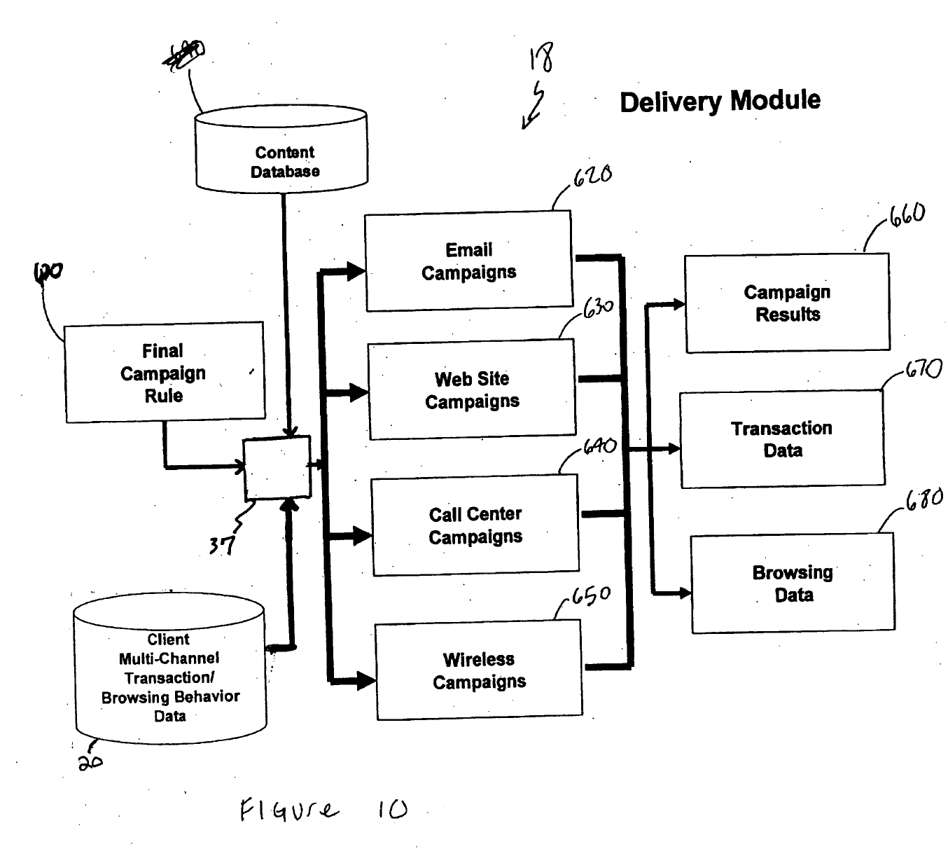

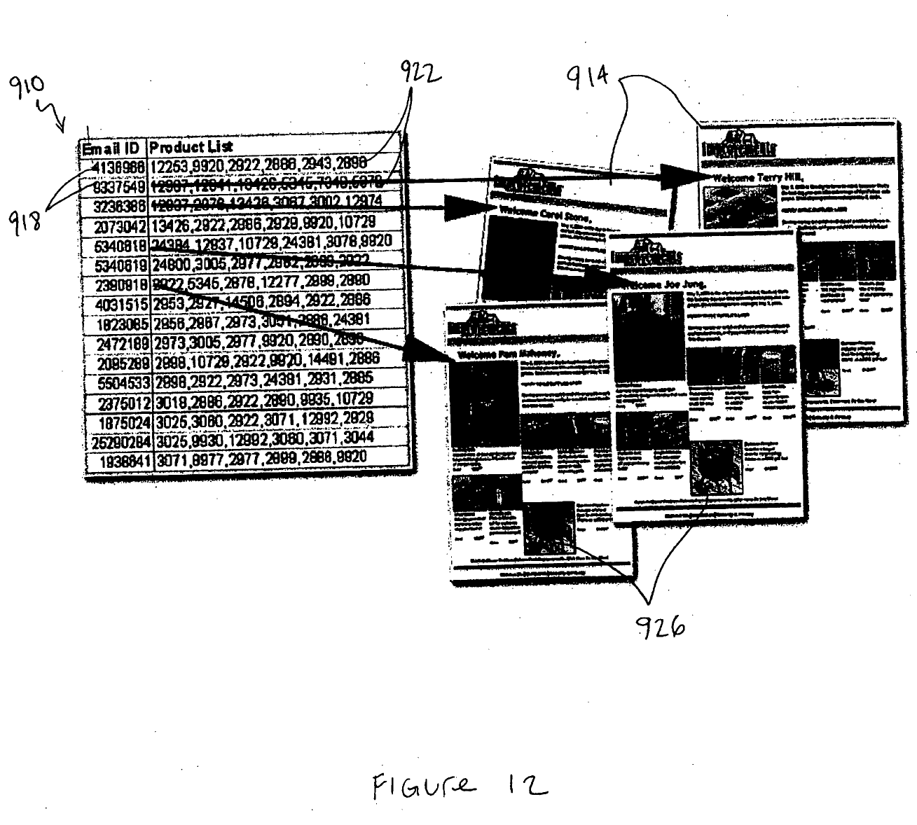

Once the above elements are determined, the delivery of a Brand Personalized campaign requires two types of data. These are the transaction data 20 (FIG. 1A), and the content data 36 (FIG. 1A). This data is processed against the final campaign rule(s) in a process 37 (FIG. 10), as follows:
The selected rule is applied to the client's individual customers' transaction data to determine the offer to be received by each customer (see 910 in FIG. 12).
From the resulting file, the appropriate content (e.g. products, offers, etc. . . ) are identified.
Using the selected template, the content are used to populate each individual customer communication (e.g. email).

FIG. 10 illustrates delivery module 18 in greater detail. Based on final campaign rule 420, an email 620, website 630, call center 640, or wireless campaign 650 are executed. By way of example, an email campaign 620 will now be described wherein a plurality of personalized emails are generated for sending out to customers, based on final campaign rule 420. These personalized recommendations consist of a set of products, content and offers chosen specifically for each customer. These recommendations are stored in content database 690, and are added into each email as it is created and sent out. They may appear almost anywhere within an email template, and can have their own graphics, price information, offers, links, descriptions, and other attributes, which are stored within database 690. The recommendations are automatically inserted into the HTML or text of a message seamlessly by way of customized tags (not shown) placed within the template. The final output is an email consisting of properly formatted HTML (or text), containing the recommendations for the individual. The format is restricted to a specific number of fields or cells or locations that can contain customized content.

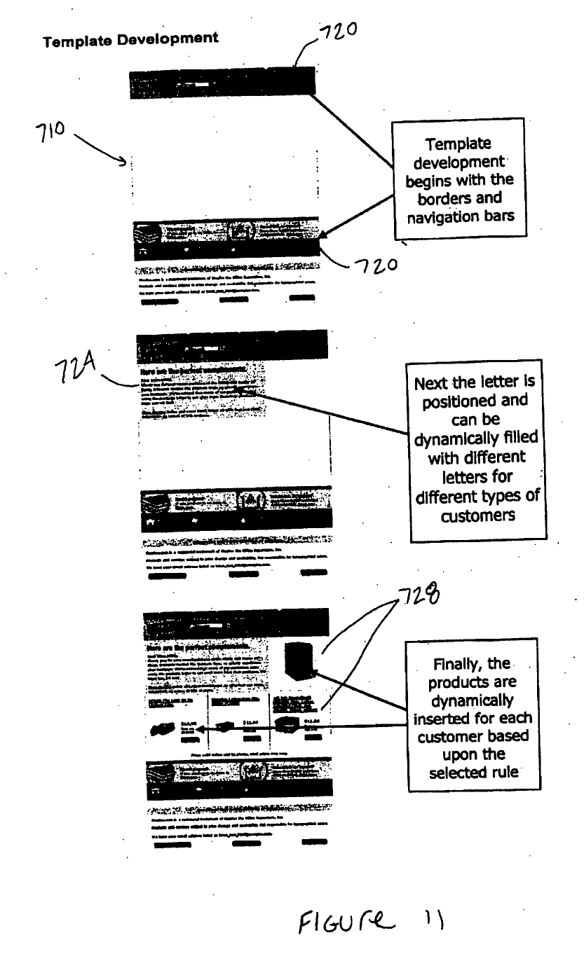

More specifically, template development begins with creating the borders and navigation bars 720, as shown in FIG. 11. Next, the letter 724 is positioned and can be dynamically filled with different letters for different types of customers. Finally, the products 728 are dynamically inserted for each customer based upon the final campaign rule 610. Examples of email types (not shown) used in template 710 include a first type, HTML multipart, which contains full HTML. It also contains a text-only version, so that individuals who are not using an HTML-capable reader can view the text version. Another email type, AOL Multipart, contains HTML, and a text-only version formatted to AOL specifications. A third type, Text Only, contains a text-only email. It is used for individuals who are unable to handle MIME multipart formats. Advantageously, each text version of all three types contains a link that dynamically generates the HTML version of the email within the recipient's browser, with all personalized elements included. By this method, the recipient can view the full copy exactly as intended, with all personalized content included.

FIG. 12 illustrates an example of an email campaign matrix 910 utilized in generating a plurality of personalized emails 914. Matrix 910 includes an Email ID 918 which identifies each of the intended recipients. A product list 922 corresponds to each Email ID 918 and is based on final campaign rule 420. Each List 922 includes, for example, SKU numbers of products 926 to be featured in emails 914.

After the emails 914 are sent out, delivery module 18 provides for tracking and reporting of transaction data 670, browsing data 680 and campaign results 660, as shown in FIG. 11. Data 660, 670, 680 includes statistics such as Emails Sent, Email Bounces, Number of customers who view the HTML template, breakdown of by Email Type (HTML, AOL, Text), Total number of product clicks, Number of individual clickers, Count each link or product was clicked, and Unsubscribe Counts. The foregoing data is tracked on an individual level. However, this information may be also summarized across dimensions such as by segment, email acquisition segment, or by email type.

Although the illustrative embodiment of the method and apparatus is described herein as including certain “modules” and process steps, it should be appreciated by those skilled in the art that the functionality described herein may be divided up in to different modules and provided in different steps.

Further, it should be appreciated that while particular marketing and/or merchandizing analyses and particular objectives, it should be appreciated by those skilled in the art that other bases for analysis of customer behavior and other commercial objectives may be considered and implemented in developing findings according to the invention.

Among the additional applications of this invention are the use of the same rules based approach to populate web site pages with offers relevant to the individual visitor. Also, recommendations could be delivered to customers calling in orders to a call center based upon their prior purchasing behavior. Data driven notifications of special offers, product availability or new products could be sent via wireless technology to cell phones and PDAs.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method for optimizing a business/marketing campaign, the method comprising the steps of:
providing, for a plurality of subscribers, transaction data relating to transactions performed via a plurality of sales channels during a predetermined time period;
analyzing transaction data of a first subscriber using a plurality of business analytics/metrics to calculate findings;
identifying, for said first subscriber, a plurality of campaign objectives as a function of said findings;
providing a plurality of campaign rules based on the transaction data of said plurality of subscribers;
selecting, from said plurality of campaign rules, campaign rules as a function of said campaign objectives; and
delivering, to at least one of said first subscriber's customers, a personalized communication as a function of said selected campaign rules and said at least one of said first subscriber's customers individual transaction history information.

2. The method of claim 1, wherein said sales channels including internet sites, retail stores, call centers, and catalog orders.

3. The method of claim 1, wherein said transaction data includes data relating to customers' purchases, said customer purchase data including at least one of (i) a type of item purchased; and (ii) the amount spent.

4. The method of claim 1, wherein said analytics are based upon of one of recency of order, order frequency, average order value, value contribution, relationship stage, and product purchasing patterns at the category, sub-category and SKU level.

5. The method of claim 1, wherein said findings include marketing findings selected from the group consisting of: Percent of one time buyers, Percent of three or more time buyers, Average order value (AOV) at 25%, AOV at 90%, AOV ratio, Percent of buyers at 0-6 months, Percent of buyers at 13+ months, Sales to order ratio low frequency/low AOV, Sales to order ratio high frequency/high AOV, Sales to order ratio low frequency/0-6 months, Sales to order ratio high frequency/0-6 months, Sales to order ratio low frequency/13+ months, and Sales to order ratio high frequency/13+ months.

6. The method of claim 1, wherein said findings include merchandising findings selected from the group consisting of: Category Sales Highest Deviation, Category Sales Lowest Deviation, Category Sales High/Low Ratio, Category Affinity Highest Percent, Category Affinity Lowest Percent, Category Affinity Average Percent, Sub-Category Low/Low-High/High Top 10 Overlap, Sub-Category Sales Ratio 1 to 20, Product Affinity Top 15 Average, Product Affinity 101-115 Average, and Product Affinity Ratio.

7. The method of claim 1, wherein said campaign objectives include 1) marketing objectives expressed in terms of one of average order value, frequency, recency, AOV by frequency, and recency by frequency; and 2) merchandising objectives expressed in terms of one of category, sub-category, SKU, category affinity, or SKU affinity.

8. The method of claim 1, wherein each campaign rule includes a rule type component that defines a statistical treatment of said transaction data, and said rule type is selected from one of Category, Multi-Category, Category Affinity, Product Affinity, Reactivation, Replenishment, Sales Add-On, Event Driven, Educational, Liquidation, Click Stream, or Multi-Channel rule types.

9. The method of claim 1, wherein each rule includes a customer definition component that defines customers purchases, and said customer definition is selected from one of Most Recent Purchase, Highest Total Amount, Highest Total Units, Highest Price, Date of Most Recent Purchase, Number of Purchases, or Average Order Value.

10. The method of claim 1 wherein each campaign rule includes a product definition component that defines selection of products to be offered to customers, and said product definition is selected from one of Overall Best Sellers, Category Best Sellers, Seasonal Items, New Products, Price Point, Brand, Overstocks, and High Margin.

11. A marketing optimization system, comprising:
a database containing transaction data for a plurality of subscribers, said transaction data relating to transactions made through a plurality of sales channels;
an analysis module for applying, to transaction data of a first subscriber, a plurality of analyses to calculate findings characterizing said data;
an objectives module for generating a plurality of objectives relating to the findings of said analyses;
a rules library containing rules based on said transaction data of said plurality of subscribers;
a rules module for selecting, from said rules library, a final campaign rule as a function of the generated objectives,
a delivery module for generating, for at least one of said first subscriber's customers, a personalized communication based on said final campaign rule and said at least one of said first subscriber's customers individual transaction information.

12. The system according to claim 11, wherein said communication is an email message that includes products, content and offers.

13. The system according to claim 12, wherein said transaction data of said plurality of said subscribers includes at least two years of at least one of clickstream/browsing data, purchase/sales data, zip codes, or addresses left behind by customers at a respective subscriber's website.

14. The system according to claim 11, wherein said analyses includes a marketing analysis of said first subscriber's transaction data as a function of one of recency of order, order frequency, or average order value.

15. The system according to claim 11, wherein said analyses includes a merchandizing analysis of said first subscriber's transaction data as a function of one of value contribution, relationship stage, and product purchasing patterns at the category, sub-category and SKU level.

16. The system of claim 11, wherein each of said campaign rules includes components selected from (i) one of a first group of components that defines a statistical treatment of said transaction data; (ii) one of a second group of component that defines customers purchases; and (iii) one of a third group of component that defines selection of products to be offered to customers.

17. The system of claim 16, wherein based on selection of the first, second, and third components, a first final campaign rule is determined.

18. The system of claim 17, wherein where: (i) the first component selected is category affinity, (ii) the second component selected is highest total units, and (iii) the third component selected is new products, then said first final campaign rule is:
a category affinity based upon an analysis calculating cross category potential, so that a buyer's category is selected based upon a category from which the buyer has purchased the most units, and so that the buyer receives two new products each from the category the buyer purchased and two highest affinity categories.

19. The system of claim 13, wherein after said email is sent out, said delivery module provides for tracking and reporting of the first subscriber's transaction data, browsing data, and campaign results.

20. The system of claim 19, wherein the data tracked and reported includes the numbers of emails sent, the numbers of email bounces, and a breakdown of email types.
